(19) United States
(12) Patent Application Publication
(10) Pub. No.: US 2011/0064984 A1
(43) Pub. Date: Mar. 17, 2011

(54) SOLAR BATTERY MODULE SUBSTRATE AND SOLAR BATTERY MODULE

(75) Inventors: Kazuaki TATSUMI, Osaka-shi (JP); Kohji MIYATA, Osaka-shi (JP); Hiroyuki NAKANISHI, Osaka-shi (JP); Masahiro OKITA, Osaka-shi (JP); Masato YOKOBAYASHI, Osaka-shi (JP)

(73) Assignee: SHARP KABUSHIKI KAISHA, Osaka (JP)

(21) Appl. No.: 12/882,386

(22) Filed: Sep. 15, 2010

(30) Foreign Application Priority Data
Sep. 17, 2009 (JP) 2009-215897

(51) Int. Cl. H01M 6/30

(52) U.S. Cl. 429/111

(57) ABSTRACT

A solar battery module substrate includes an insulating substrate on which a conductive pattern and an insulating protective film are formed, the conductive pattern including: cathode mounting terminals each of which is to be connected with a cathode of a solar battery cell; anode mounting terminals each of which is to be connected with an anode of the solar battery cell; and first module wiring, the first module wiring connecting a cathode mounting terminal to be connected with a cathode of one solar battery cell with an anode mounting terminal to be connected with an anode of another solar battery cell connected in series with said one solar battery cell, the insulating protective film having at least one opening for exposing the cathode mounting terminal and the anode mounting terminal, and the opening being positioned inside a portion of the solar battery module substrate on which portion the solar battery cell is to be projected.

This Nonprovisional application claims priority under 35 U.S.C. §119(a) on Patent Application No. 2009-215897 filed in Japan on Sep. 17, 2009, the entire contents of which are hereby incorporated by reference.

### TECHNICAL FIELD

The present invention relates to a solar battery module substrate and a solar battery module.

### BACKGROUND ART

A silicon-based solar battery cell has an electromotive force of approximately 0.5V, and there is a case where an electromotive force of one solar battery cell is not sufficient to operate a desired electric circuit. Accordingly, in a conventional art, a plurality of solar battery cells are connected with each other in series to form a solar battery module, thereby obtaining an electromotive force necessary for a desired electric circuit.

On the other hand, a solar battery cell having a cathode and an anode for extracting an electric force at the back solar battery cell) is expected as a highly efficient solar battery cell which does not suffer from a drop in optical power generation performance due to the shades of electrodes formed on the front surface of the solar battery cell, compared with a conventional solar battery cell having a cathode and an anode for extracting an electric force on a back surface and a front surface, respectively.

FIG. 18 is an explanatory drawing showing operations of a conventional back surface electrode type solar battery cell 101. (a) to (c) of FIG. 18 are drawings showing operations of the conventional back surface electrode type solar battery cell 101. In the drawing, since the back surface electrode type solar battery cell 101 is used for a later-mentioned large solar battery module for housing etc., the back surface electrode type solar battery cell 101 is made of a whole wafer. A front surface 102 of the back surface electrode type solar battery cell 101 shown in (a) of FIG. 18 has a textual structure for preventing reflection of light, and incident light 104 from the sun 103 is incident to the front surface 102.

Further, as shown in (b) of FIG. 18, on a back surface 105 of the back surface electrode type solar battery cell 101, positive electrodes (cathodes) 106 and negative electrodes (anodes) 107 are positioned alternately (striped manner). In FIG. 18, the positive electrodes 106 and the negative electrodes 107 are not exposed at edges of the back surface electrode type solar battery cell 101. This is because the positive electrodes 106 and the negative electrodes 107 are not extended to the edges of the back surface electrode type solar battery cell 101 in consideration of holding peripherals of a wafer in wafer processing.

When the incident light 104 is incident to the back surface electrode type solar battery cell 101, an electron-hole pair 108 is excited in the back surface electrode type solar battery cell 101, as shown in (c) of FIG. 18 which is a cross sectional drawing taken in A-A″ line which is a part of a cross sectional drawing taken in A-A′ line of (b) of FIG. 18. Among the excited electron-hole pair 108, an electron 109 reaches the negative electrode 107 and a hole 110 reaches the positive electrode 106. Thus, it is possible to extract an electromotive force from the back surface electrode type solar battery cell 101. As a distance W 101 between the positive electrode 106 and the negative electrode 107 is shorter, the efficiency of the back surface electrode type solar battery cell 101 increases.

As a solar battery including the back surface electrode solar battery cell, Patent Literature 1 discloses a solar battery in which electrodes of a solar battery cell are electrically connected with wiring of a wiring substrate at a low temperature with easiness. Electrodes of the back surface electrode type solar battery cell are electrically connected with wiring of a wiring substrate and the cell is sealed with a sealing member. Thus, a solar battery module is provided.

### Citation List

[Patent Literature]

[Patent Literature 1]

Japanese Patent Application Publication Tokukai No. 2009-88145 (publication date: Apr. 23, 2009).

### SUMMARY OF INVENTION

### Technical Problem

The solar battery cell and the solar battery module disclosed in Patent Literature 1 are made of a wafer without cutting it. In the vicinity of the edges, there is a portion where terminals cannot be provided due to wafer processing, and where contact etc. with an electrode is not made. However, for example, in a case where a cell designed to be used as a module while maintaining its wafer size is cut into a plurality of modules, there arises a problem that an electrode is exposed in the vicinity of edges and contacts with its surrounding. Such problem has not been discussed so far.

The present invention was made in view of the foregoing problem. An object of the present invention is to provide a solar battery module substrate and a solar battery module in each of which an exposed electrode does not touch with its surrounding.

### Solution to Problem

In order to solve the foregoing problem, a solar battery module substrate of the present invention on which solar battery cells are to be mounted includes an insulating substrate on which a conductive pattern and an insulating protective film are formed, the conductive pattern including: cathode mounting terminals each of which is to be connected with a cathode of a solar battery cell; anode mounting terminals each of which is to be connected with an anode of the solar battery cell; and first module wiring, the first module wiring connecting a cathode mounting terminal to be connected with a cathode of one solar battery cell with an anode mounting terminal to be connected with an anode of another solar battery cell connected in series with said one solar battery cell, the insulating protective film having at least one opening for exposing the cathode mounting terminal and the anode mounting terminal, and the opening being positioned inside a portion of the solar battery module substrate on which portion the solar battery cell is to be projected.

With the invention, the solar battery module substrate includes the insulating protective film having at least one opening. This allows electrical connection between the solar battery cell and the conductive pattern. Further, even if a part of an electrode of the solar battery cell is exposed, i.e. even if a portion where an electrode is exposed appears, provision of the insulating protective film between the portion where the electrode is exposed and the first module wiring prevents the portion where the electrode is exposed and the first module wiring from contacting with each other improperly.

Further, a cell distance between two solar battery cells on the solar battery module substrate of the present invention can be smaller than a cell distance on a conventional solar battery module substrate. Accordingly, a solar battery module including the solar battery module substrate can output an electromotive force corresponding to its size.

A solar battery module substrate of the present invention on which solar battery cells are to be mounted includes an insulating substrate on which a conductive pattern and a first insulating protective film are formed, the conductive pattern including: cathode mounting terminals each of which is to be connected with a cathode of a solar battery cell; anode mounting terminals each of which is to be connected with an anode of the solar battery cell; and first module wiring, the first module wiring connecting a cathode mounting terminal to be connected with a cathode of one solar battery cell with an anode mounting terminal to be connected with an anode of another solar battery cell connected in series with said one solar battery cell, the first insulating protective film having at least one first opening for exposing the cathode mounting terminal and at least one second opening for exposing the anode mounting terminal, said at least first opening and said at least one second opening being positioned inside a portion of the solar battery module substrate on which portion the solar battery cell is to be projected, and a second insulating protective film being provided between the cathode mounting terminal and the anode mounting terminal.

With the invention, the solar battery module substrate includes the insulating protective film having at least one first opening and at least one second opening. This allows electrical connection between the solar battery cell and the conductive pattern. Further, even if a part of an electrode of the solar battery cell is exposed, i.e. even if a portion where an electrode is exposed appears, provision of the insulating protective film between the portion where the electrode is exposed and the first module wiring prevents the portion where the electrode is exposed and the first module wiring from contacting with each other improperly.

Further, a cell distance between two solar battery cells on the solar battery module substrate of the present invention can be smaller than a cell distance on a conventional solar battery module substrate. Accordingly, a solar battery module including the solar battery module substrate can output an electromotive force corresponding to its size.

Further, provision of the first opening, the second opening, and the second insulating protective film allows more surely insulating between the cathode mounting terminal and the anode mounting terminal in electrical connection between the solar battery cell and the conductive pattern. Further, provision of the second insulating protective film allows dispersing strength applied on the solar battery module substrate when the solar battery cell is mounted on the solar battery module substrate, and allows smoother sealing by transparent protective resin.

### ADVANTAGEOUS EFFECTS OF INVENTION

As described above, the solar battery module substrate of the present invention on which solar battery cells are to be mounted includes an insulating substrate on which a conductive pattern and an insulating protective film are formed, the conductive pattern including: cathode mounting terminals each of which is to be connected with a cathode of a solar battery cell; anode mounting terminals each of which is to be connected with an anode of the solar battery cell; and first module wiring, the first module wiring connecting a cathode mounting terminal to be connected with a cathode of one solar battery cell with an anode mounting terminal to be connected with an anode of another solar battery cell connected in series with said one solar battery cell, the insulating protective film having at least one opening for exposing the cathode mounting terminal and the anode mounting terminal, and the opening being positioned inside a portion of the solar battery module substrate on which portion the solar battery cell is to be projected.

As described above, the solar battery module substrate of the present invention on which solar battery cells are to be mounted includes an insulating substrate on which a conductive pattern and a first insulating protective film are formed, the conductive pattern including: cathode mounting terminals each of which is to be connected with a cathode of a solar battery cell; anode mounting terminals each of which is to be connected with an anode of the solar battery cell; and first module wiring, the first module wiring connecting a cathode mounting terminal to be connected with a cathode of one solar battery cell with an anode mounting terminal to be connected with an anode of another solar battery cell connected in series with said one solar battery cell, the first insulating protective film having at least one first opening for exposing the cathode mounting terminal and at least one second opening for exposing the anode mounting terminal, said at least first opening and said at least one second opening being positioned inside a portion of the solar battery module substrate on which portion the solar battery cell is to be projected, and a second insulating protective film being provided between the cathode mounting terminal and the anode mounting terminal.

Therefore, the present invention provides a solar battery module substrate and a solar battery module in each of which a portion where an electrode is exposed does not contact with its surrounding improperly.

### BRIEF DESCRIPTION OF DRAWINGS

FIG. 1 is a plane drawing showing a solar battery module substrate in accordance with an embodiment of the present invention.

FIG. 2 is an explanatory drawing showing operations of a back surface electrode type solar battery cell. (a)-(c) of FIG. 2 show operations of a back surface electrode type solar battery cell.

FIG. 3 is a drawing showing production of a back surface electrode type solar battery cell from a back surface electrode type cell wafer for housing. (a)-(c) of FIG. 3 shows production of a back surface electrode type solar battery cell from a back surface electrode type cell wafer for housing.

FIG. 4 is a plane drawing showing a module substrate in accordance with an embodiment of the present invention.

FIG. 5 is a plane drawing showing a module substrate to which solder paste is supplied.

FIG. 6 is a drawing showing mounting a back surface electrode type solar battery cell in an inverted manner.

FIG. 7 is a plane drawing showing a solar battery module completed by being sealed with transparent protective resin, in accordance with the present embodiment.

FIG. 8 is a cross sectional drawing taken in line A-B of the solar battery module substrate shown in FIG. 1.

FIG. 9 is a plane drawing showing another solar battery module substrate in accordance with an embodiment of the present invention.

FIG. 10 is a plane drawing showing still another solar battery module in accordance with an embodiment of the present invention. (a) of FIG. 10 is a plane drawing showing a front surface of the solar battery module. (b) of FIG. 10 shows a plane drawing showing a back surface of the solar battery module.

FIG. 11 is a plane drawing showing a back surface of a back surface electrode type solar battery cell on which back surface positive electrodes and negative electrodes are positioned in a checkered pattern.

FIG. 12 is an explanatory drawing showing how to make a back surface electrode type solar battery cell from a back surface electrode type cell wafer for housing. (a)-(c) of FIG. 12 show how to make a back surface electrode type solar battery cell from a back surface electrode type cell wafer for housing.

FIG. 13 is a plane drawing showing a module substrate for the purpose of preliminary discussion.

FIG. 14 is a plane drawing showing a module substrate to which solder paste is supplied, for the purpose of preliminary discussion.

FIG. 15 is a drawing showing mounting a back surface electrode type solar battery cell in an inverted manner.

FIG. 16 is a plane drawing showing a solar battery module completed by being sealed with transparent protective resin.

FIG. 17 is a drawing showing providing a broad cell distance on a solar battery module.

FIG. 18 is an explanatory drawing showing operations of a conventional back surface electrode type solar battery cell. (a) to (c) of FIG. 18 are drawings showing operations of the conventional back surface electrode type solar battery cell.

### DESCRIPTION OF EMBODIMENTS

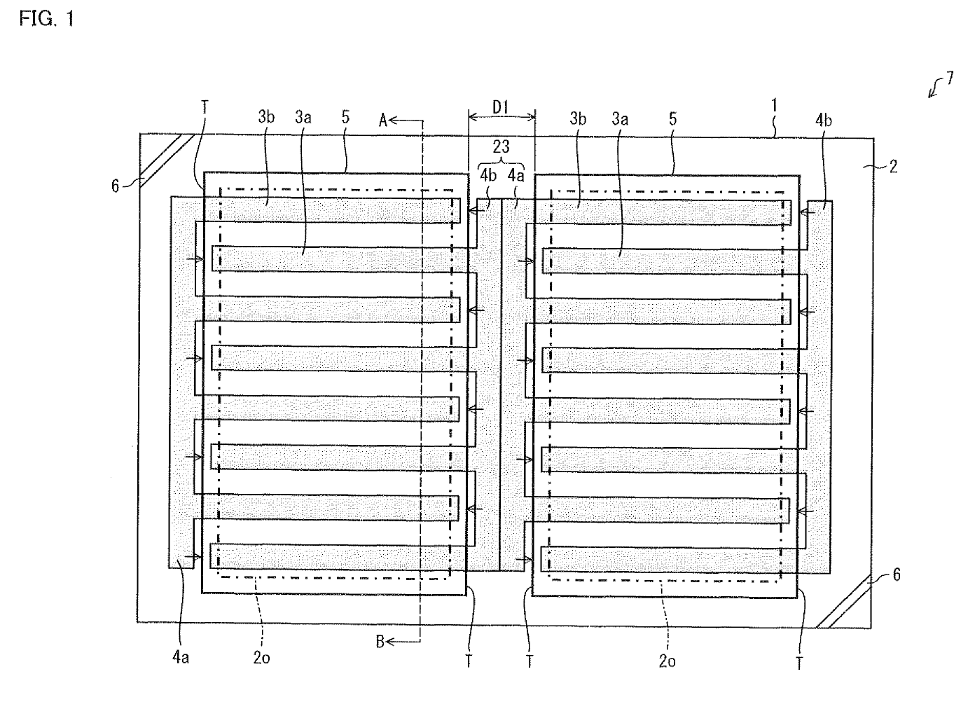

One embodiment of the present invention is explained below with reference to FIGS. 1 to 17.

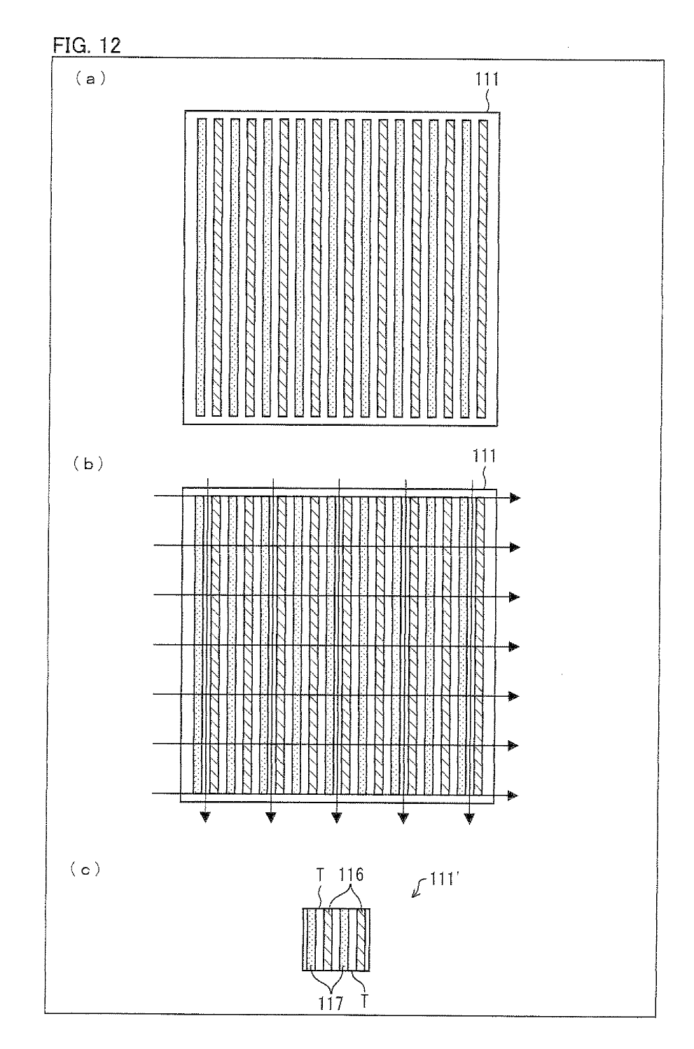

Preliminary discussion on a back surface electrode type solar battery cell will be made here with reference to FIGS. 12-17.

An explanation is made as to a case where a back surface electrode type solar battery cell is made by cutting a wafer in order that the back surface electrode type solar battery cell may have any module size (i.e. chip size). FIG. 12 is an explanatory drawing showing how to make the back surface electrode type solar battery cell from a back surface electrode type cell wafer for housing. Here, it is assumed that a back surface electrode type cell wafer 111 shown in (a) of FIG. 12 is cut into cells as shown in (b) of FIG. 12.

In this case, there is a possibility that a part of a positive electrode (cathode) 116 and a part of a negative electrode (anode) 117 are exposed at edges T (cell edges) of a back surface electrode type solar battery cell 111′ having been cut as shown in (c) of FIG. 12. A length of the exposed part of the electrode is approximately several μm.

In FIG. 12, the back surface electrode type cell wafer 111 is used for housing as it is, i.e. without cutting the back surface electrode type cell wafer 111. Cutting of the wafer in (b) of FIG. 12 is performed with a circular saw. Thus, the back surface electrode type solar battery cell 111′ having a predetermined size (shown in (c) of FIG. 12)) is obtained.

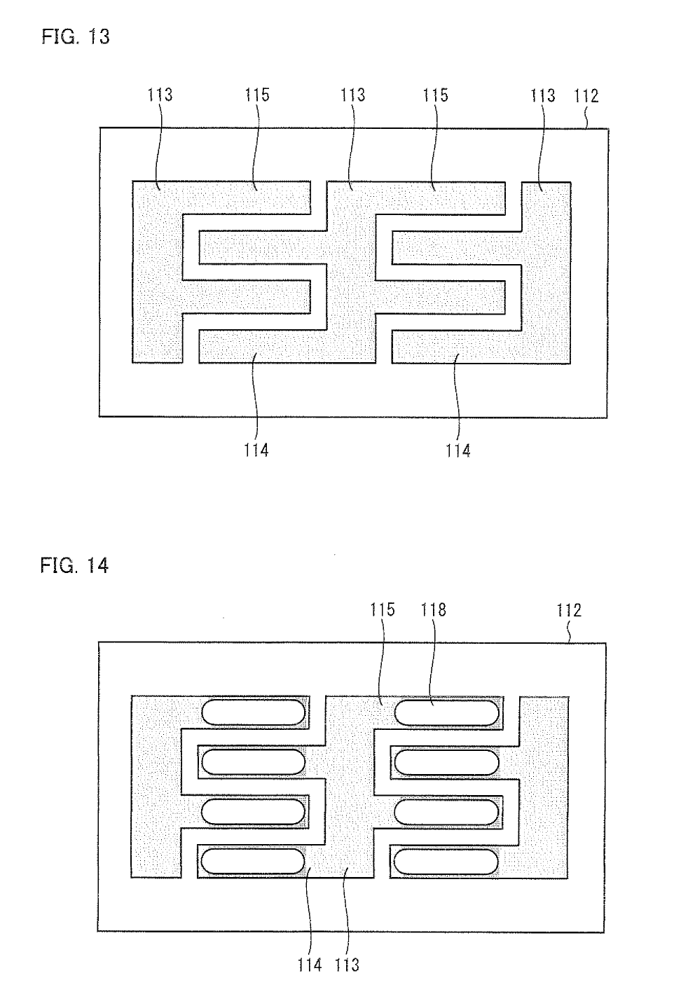

The following explains mounting the back surface electrode type solar battery cell 111′. On a solar battery module substrate 112 of FIG. 13, there are provided module wiring 113, a cathode mounting terminal 114 connected with the module wiring 113, and an anode mounting terminal 115 connected with the module wiring 113.

Subsequently, a solder paste 118 is supplied to the solar battery module substrate 112 as shown in FIG. 14 (solder printing). The solder paste 118 is supplied only to a portion where the solder paste 118 is required, i.e. the cathode mounting terminal 114 and the anode mounting terminal 115. A conductive adhesive may be used instead of the solder paste 118.

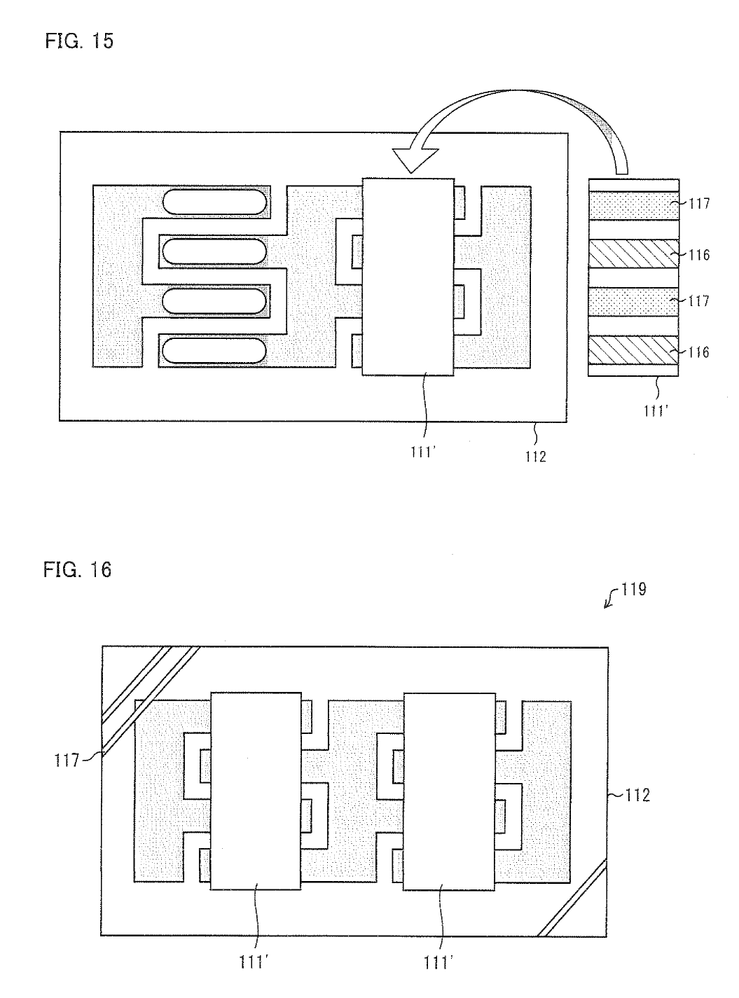

Further, on the solar battery module substrate 112 to which the solder paste 118 has been supplied, the back surface electrode type solar battery cell 111′ is mounted as a flip chip, i.e. in an inverted manner, as shown in FIG. 15. Then, the whole of the solar battery module substrate 112 on which the back surface electrode type solar battery cell 111′ has been mounted is sealed with transparent protective resin 117 as shown in FIG. 16. Thus, a solar battery module 119 is completed.

In the solar battery module 119, when the back surface electrode type solar battery cells 111′ each having on its back surface a cathode and an anode from which an electric power can be extracted are connected with each other in series to have a larger electromotive force, it is necessary to insulate between the cathode of the back surface electrode type solar battery cell 111′ and the anode of the same back surface electrode type solar battery cell 111′ and between the cathode of one of two back surface electrode type solar battery cells 111′ connected with each other in series and the anode of the other.

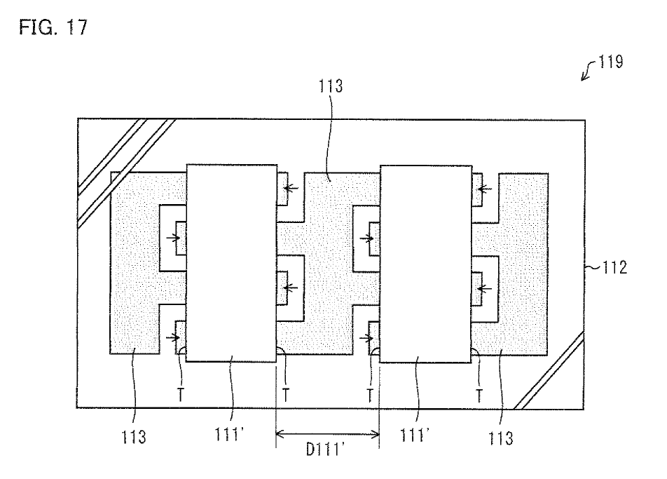

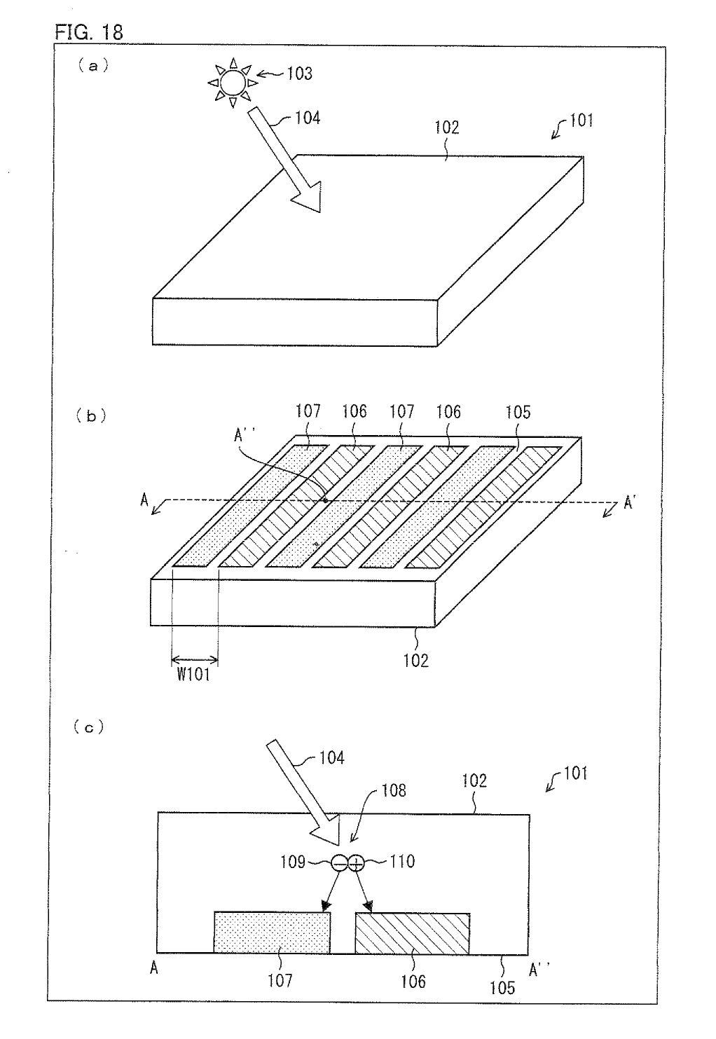

However, there is a case where the exposed portion of the electrode appears at portions indicated by arrows in the solar battery module 119 in FIG. 17. Therefore, it is necessary to design the solar battery module 119 such that an exposed part of the electrode at an edge T of the back surface electrode type solar battery cell 111′ does not improperly contact with the module wiring 113 when the back surface electrode type solar battery cell 111′ is mounted on the solar battery module substrate 112. This necessitates widening a cell distance D111′.

As described above, the solar battery module 119 obtained by connecting the back surface electrode type solar battery cells 111′ in series on the solar battery module substrate 112 has large cell distance D111′ between two solar battery cells. Consequently, the solar cell module 119 gets larger and unable to output an electromotive force corresponding to the size of the solar battery module 119. Consequently, the solar cell module cannot fully exhibit its feature of not suffering from a drop in optical power generation performance.

The present invention was made as a result of the preliminary discussion on a back surface electrode type solar battery cell.

FIG. 1 is a plane drawing showing a solar battery module substrate in accordance with the present embodiment. The solar battery module substrate 1 includes, on an insulating substrate, an insulating protective film 2 (insulating protective film, first insulating protective film), a cathode mounting terminal 3a, an anode mounting terminal 3b, module wiring 4a connected with the cathode mounting terminal 3a, and module wiring 4b connected with the anode mounting terminal 3b. The insulating substrate is made of glass epoxy for example.

The insulating protective film 2 includes an opening 2o (opening). The opening 2o is for exposing the cathode mounting terminal 3a and the anode mounting terminal 3b, and is provided inside a portion indicted by thick line in FIG. 1, i.e. a portion where a back surface electrode type solar battery cell 5 (solar battery cell) is projected.

Mounting a back surface electrode type solar battery cell 5 (mentioned later) on the solar battery module substrate 1 and sealing the solar battery module substrate 1 with transparent protective resin 6 results in a solar battery module 7.

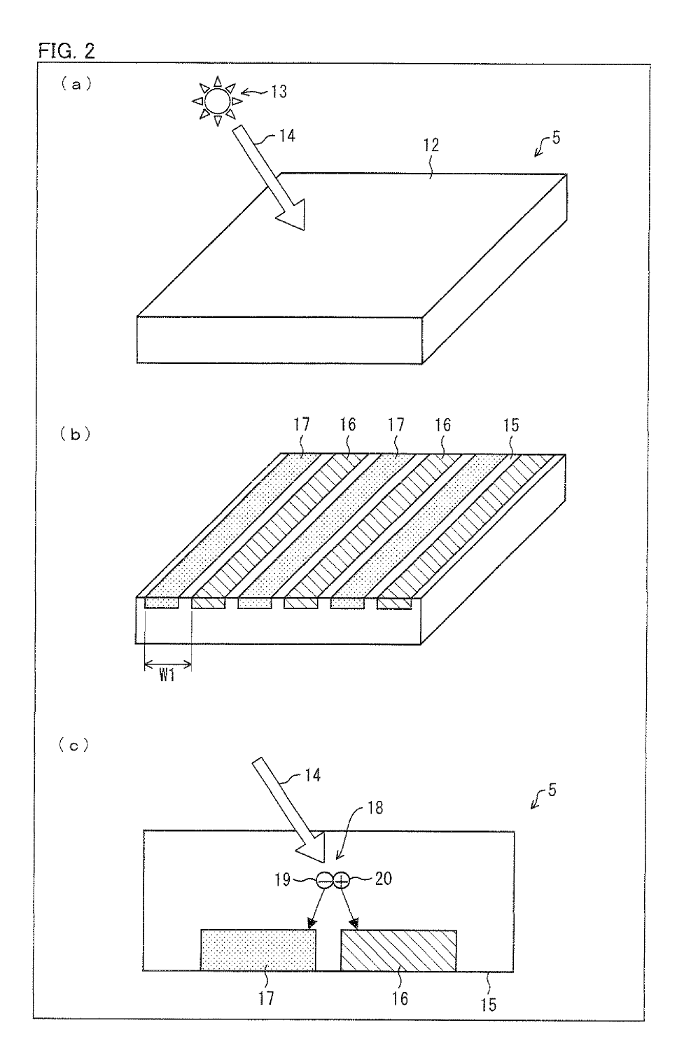

FIG. 2 is an explanatory drawing showing operations of the back surface electrode type solar battery cell 5. (a) to (c) of FIG. 2 show the operations of the back surface electrode type solar battery cell 5. The back surface electrode type solar battery cell is a solar battery cell having a positive electrode and a negative electrode on its back surface and having no electrodes (no positive electrode and no negative electrode) on its front surface.

A surface 12 of the back surface electrode type solar battery cell 5 shown in (a) of FIG. 2 has a texture structure for preventing reflection of light, and incident light 14 from the sun 13 is incident to the surface 12.

Further, as shown in (b) of FIG. 2, on a back surface 15 of the back surface electrode type solar batter cell 5, a positive electrode (cathode) 16 and a negative electrode (anode) 17 are positioned alternately (in a striped manner). The shape of the positive electrode 16 and the negative electrode 17 is a rectangular parallelepiped, and the length of a long side of the rectangular parallelepiped is equal to the length of a side of the back surface electrode type solar battery cell 5.

When the incident light 14 is incident to the back surface electrode type solar battery cell 5 having the above configuration, an electron-hole pair 18 is excited in the back surface electrode type solar battery cell 5 as shown in (c) of FIG. 2. Out of the excited electron-hole pair 18, an electron 19 reaches the negative electrode 17 and the hole 20 reaches the positive electrode 16. This allows extracting an electromotive force from the back surface electrode type solar battery cell 5. As a distance W1 between the positive electrode 16 and the negative electrode 17 is shorter, the efficiency of the back surface electrode type solar battery cell 5 increases. The distance W1 is 0.75 mm for example.

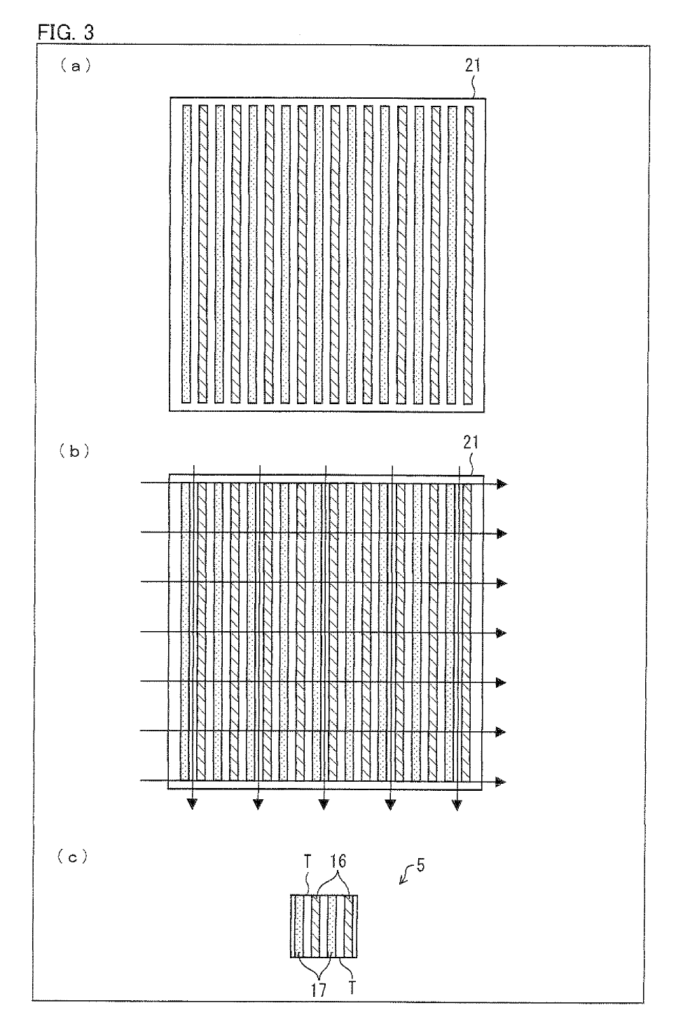

FIG. 3 is a drawing showing production of the back surface electrode type solar battery cell 5 from a back surface electrode type cell wafer 21 for housing. The back surface electrode type solar battery cell 5 shown in FIG. 2 may be produced by cutting, as shown in (b) of FIG. 3, the back surface type electrode cell wafer 21 for housing shown in (a) of FIG. 3.

In this case, there is a possibility that a part of a positive electrode 16 and a part of a negative electrode 17 are exposed at edges T of the back surface electrode type solar battery cell 5 shown in (c) of FIG. 3. A length of the exposed part of the electrode is approximately several μm.

In FIG. 3, the back surface electrode type cell wafer 21 is used for housing as it is, i.e., without cutting the back surface electrode type cell wafer 21. Cutting in (b) of FIG. 3 is performed with a circular saw. Thus, the back surface electrode type solar battery cell 5 having a predetermined size (shown in (c) of FIG. 3)) is obtained.

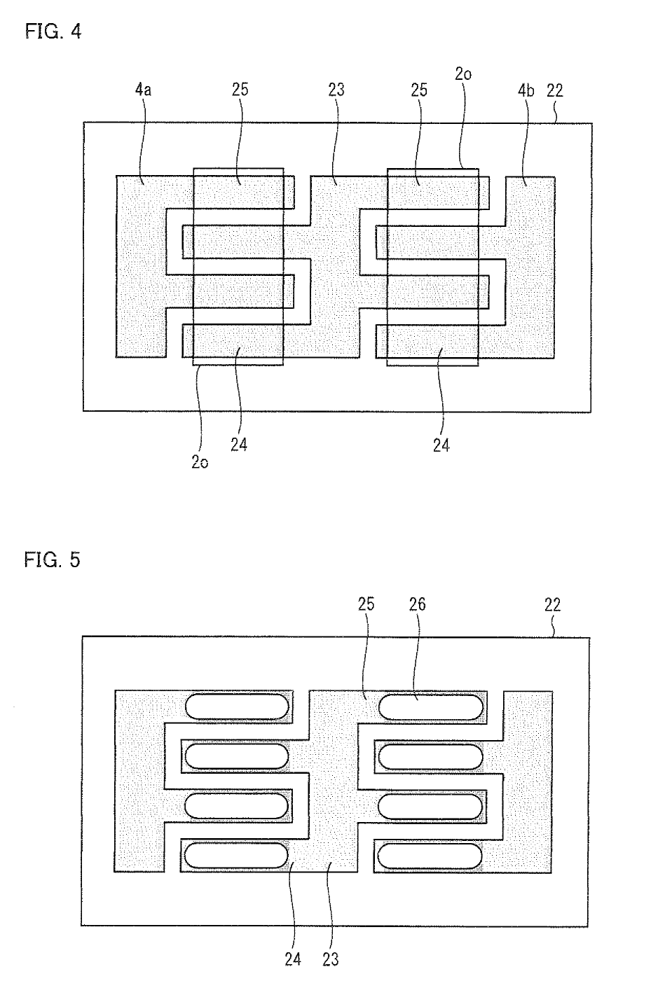

The following explains mounting the back surface electrode type solar battery cell 5. FIG. 4 is a plane drawing illustrating the solar battery module substrate 22 of the present embodiment. On a solar battery module substrate 22 of FIG. 4, there are provided module wiring 4a, module wiring 4b, module wiring 23 (first module wiring), a cathode mounting terminal 24 connected with the module wiring 23, and an anode mounting terminal 25 connected with the module wiring 23. The module wiring 4a, the module wiring 4b, the module wiring 23, the cathode mounting terminal 24, and the anode mounting terminal 25 constitute a conductive pattern. The module wiring 23 includes the module wiring 4a and the module wiring 4b.

Further, the insulating protective film 2 is provided so as to cover the whole of the solar battery module substrate 22, i.e. the module wiring 23, the cathode mounting terminal 24, and the anode mounting terminal 25. The insulating protective film 2 has an opening 2o.

Subsequently, a solder paste 26 is supplied to the solar battery module substrate 22 as shown in FIG. 5 (solder printing). The solder paste 26 is supplied only to a portion where the solder paste 26 is required, i.e. the cathode mounting terminal 24 and the anode mounting terminal 25.

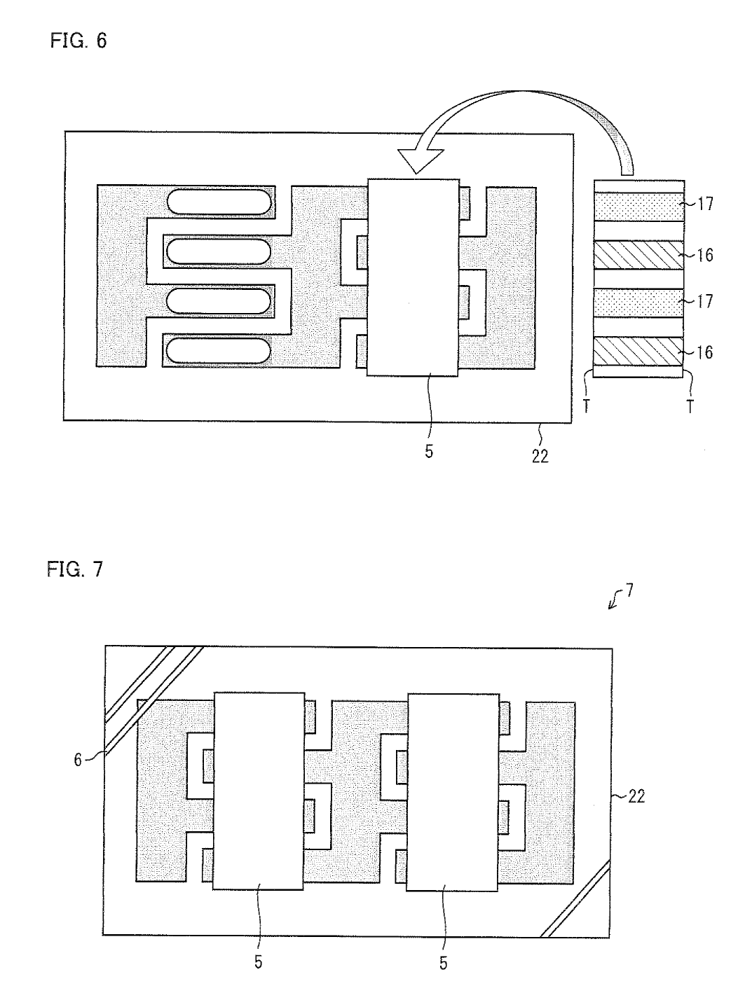

Further, on the solar battery module substrate 22 to which the solder paste 26 has been supplied, the back surface electrode type solar battery cell 5 is mounted as a flip chip, i.e. in an inverted manner, as shown in FIG. 6. Then, the whole of the solar battery module substrate 22 on which the back surface electrode type solar battery cell has been mounted is sealed with transparent protective resin 6 as shown in FIG. 7. Thus, a solar battery module 7 is completed.

In the above example, connection is made using a solder paste. Alternatively, connection may be made using a conductive adhesive, an anisotropic conductive sheet etc.

In the solar battery module 7 having the above configuration, the solar battery module substrate 1 includes the insulating protective film 2 having at least one opening 2o. This allows electrical connection between the back surface electrode type solar battery cell 5 and the conductive pattern. Further, even if a part of an electrode of the back surface electrode type solar battery cell 5 (a part of the positive electrode 16 or a part of the negative electrode 17) is exposed at a portion indicated by an arrow of an edge T of the back surface electrode type solar battery cell 5 in FIG. 1, i.e. even if a portion where the electrode is exposed appears, the insulating protective film 2 provided between the portion where the electrode is exposed and the module wiring 23 prevents the portion where the electrode is exposed and, the module wiring 23 from touching with each other improperly. Similarly, the insulating protective film 2 prevents the portion where the electrode is exposed and the module wiring 4a and 4b from touching with each other improperly.

The portion indicated by an arrow in FIG. 1 indicates a portion where the positive electrode 16 and the module wiring 4a are adjacent to each other and a portion where the negative electrode 17 and the module wiring 4b are adjacent to each other.

Consequently, on the solar battery module substrate 1, a cell distance D1 between the two back surface electrode type solar battery cells 5 can be shorter than the cell distance D111′ (FIG. 17) on the solar battery module substrate 112. Further, the solar battery module 7 having the solar battery module substrate 1 can output an electromotive force corresponding to its size. Further, the solar battery module 7 can fully exhibit a characteristic that the back surface electrode type solar battery cell 5 does not suffer from a drop in optical power generation performance.

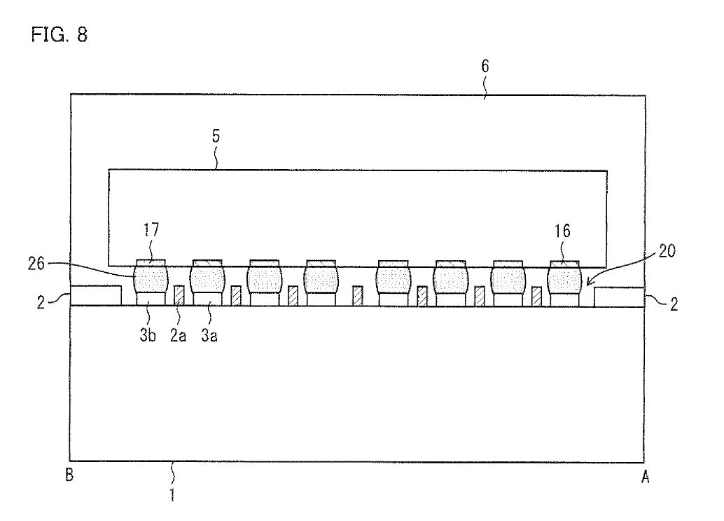

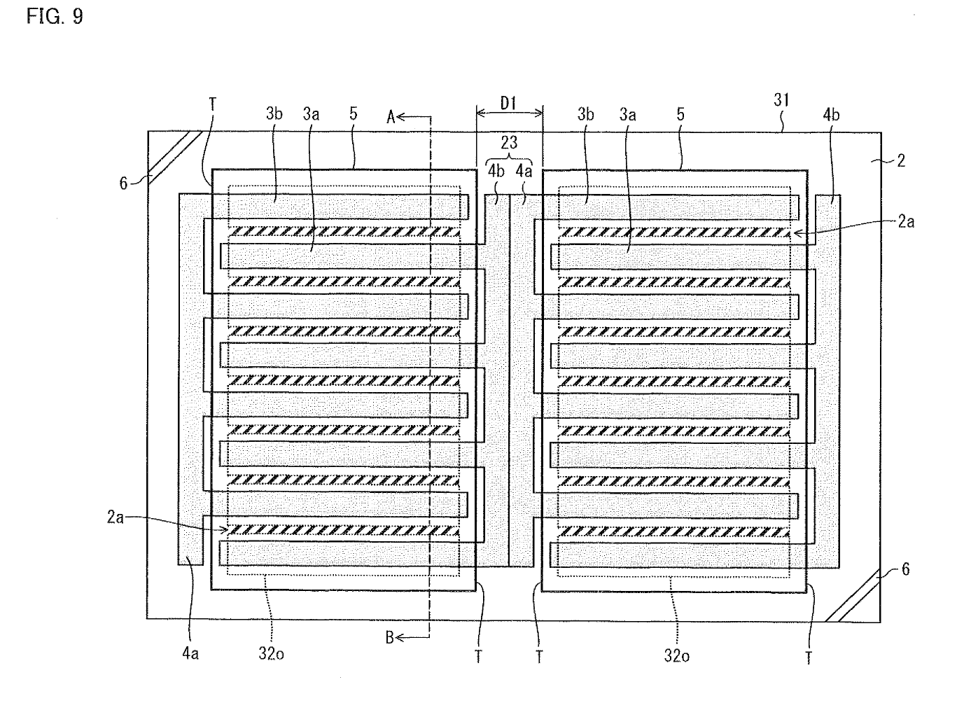

FIG. 8 is a cross sectional drawing taken in line A-B of the solar battery module substrate 1 shown in FIG. 1. As shown in FIG. 8, the solar battery module substrate of the present embodiment may be provided with an insulating protective film 2a (a second insulating protective film) indicated by a shaded area. This configuration will be explained here with reference to a plane drawing of FIG. 9.

FIG. 9 is a plane drawing showing a solar battery module substrate 31 which is another solar battery module substrate of the present embodiment. The solar battery module substrate 31 is different from the solar battery module substrate 1 of FIG. 1 in terms of an insulating protective film and an opening.

On the solar battery module substrate 31, the insulating protective film 2 has a plurality of openings 32o smaller than the opening 2o of FIG. 1. Each opening 32o (first opening and second opening) exposes only one cathode mounting terminal 3a or only one anode mounting terminal 3b. The insulating protective film 2a is provided between two adjacent openings 32o. That is, the opening 32o and the insulating protective film 2a are provided alternately.

The solar battery module substrate 31 includes the insulating protective film 2 having at least one opening 32o. This allows electrical connection between the back surface electrode type solar battery cell 5 and the conductive pattern. Further, even if a part of an electrode of the back surface electrode type solar battery cell 5 (a part of the positive electrode 16 or a part of the negative electrode 17) is exposed at a portion indicated by an arrow of an edge T of the back surface electrode type solar battery cell 5 in FIG. 1, i.e. even if a portion where the electrode is exposed appears, the insulating protective film 2 provided between the portion where the electrode is exposed and the module wiring 23 prevents the portion where the electrode is exposed and the module wiring 23 from touching with each other improperly. Similarly, the insulating protective film 2 prevents the portion where the electrode is exposed and the module wiring 4a and 4b from touching with each other improperly.

The portion indicated by an arrow in FIG. 1 indicates a portion where the positive electrode 16 and the module wiring 4a are adjacent to each other and a portion where the negative electrode 17 and the module wiring 4b are adjacent to each other.

Consequently, on the solar battery module substrate 31, a cell distance D1 between the two back surface electrode type solar battery cells 5 can be shorter than the cell distance D111′ (FIG. 17) on the solar battery module substrate 112. Further, the solar battery module having the solar battery module substrate 31 can output an electromotive force corresponding to its size. Further, the solar battery module having the solar battery module substrate 31 can fully exhibit a characteristic that the back surface electrode type solar battery cell 5 does not suffer from a drop in optical power generation performance.

On the solar battery module substrate 31, provision of the opening 32o and the insulating protective film 2a allows the cathode mounting terminal 3a and the anode mounting terminal 3b to be more surely insulated from each other in electrical connection between the back surface electrode type solar battery cell 5 and the conductive pattern. Further, provision of the insulating protective film 2a allows dispersing a strength applied on the solar battery module substrate 31 in mounting the back surface electrode type solar battery cell 5 on the solar battery module substrate 31, and allows smoother sealing by the transparent protective resin 6.

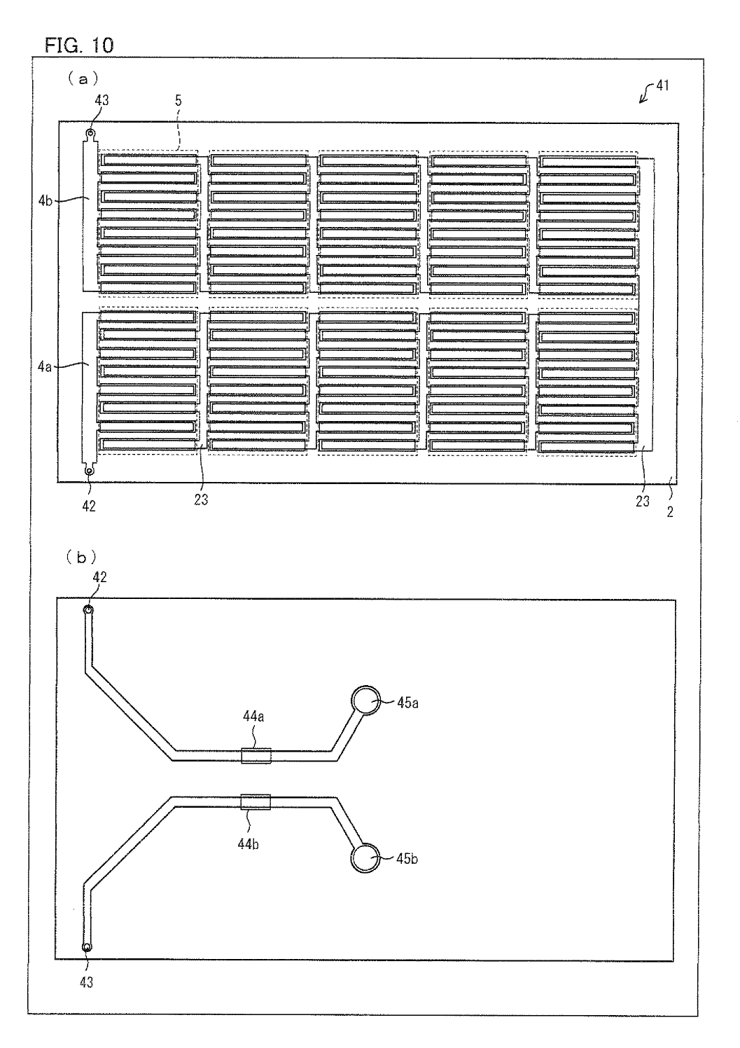

FIG. 10 is a plane drawing showing a solar battery module 41 which is still another solar battery module of the present embodiment. (a) of FIG. 10 is a plane drawing showing a front surface of the solar battery module 41. (b) of FIG. 10 shows a plane drawing showing a back surface of the solar battery module 41.

As shown in (a) of FIG. 10, in the solar battery module 41, ten back surface electrode type solar battery cells 5 are connected with each other in series. Further, an edge of the module wiring 4a is connected with the back surface electrode type solar battery cell 5. Further, an edge of the module wiring 4b is connected with the back surface electrode type solar battery cell 5. Further, the other edge (i.e. an edge which is not connected with the back surface electrode type solar battery cell 5) of the module wiring 4a is provided with a via 42 which penetrates the solar battery module 41 to the back surface thereof. Further, the other edge (i.e. an edge which is not connected with the back surface electrode type solar battery cell 5) of the module wiring 4b is provided with a via 43 which penetrates the solar battery module 41 to the back surface thereof.

Further, as shown in (b) of FIG. 10, the via 42 is connected with (i) a mounting electrode 44a connected with an electrode of a mounting substrate (not shown) on which the solar battery module 41 is mounted and (ii) a test pad 45a. The via 43 is connected with (i) a mounting electrode 44b connected with an electrode of the mounting substrate and (ii) a test pad 45b.

The module wiring 4a and 4b and the mounting electrodes 44a and 44b allow the solar battery module 41, and the mounting substrate to be electrically connected with each other.

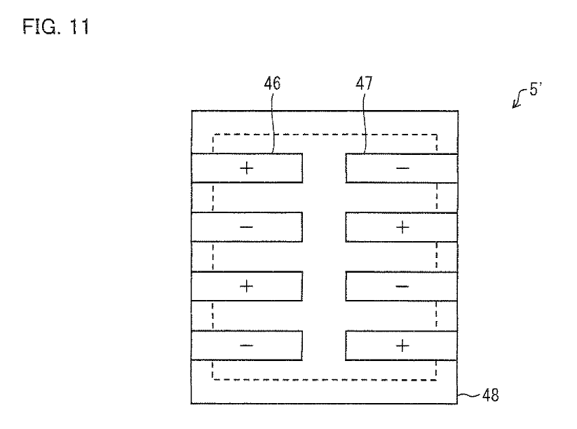

In the above explanation, the back surface electrode type solar battery cell 5 is designed such that the positive electrodes 16 and the negative electrodes 17 are positioned alternately. Alternatively, a back surface electrode type solar battery cell 5′ (solar battery cell) in which the positive electrodes 46 and the negative electrodes 47 are positioned in a checkered pattern may be used. In other words, this positioning of electrodes is such that both in two different directions (longitudinal and lateral directions in FIG. 11), at least one positive electrode 46 and at least one negative electrode 47 are provided in such a manner that electrodes of the same polarity are not adjacent to each other. The shapes of the positive electrode 46 and the negative electrode 47 are rectangular parallelepiped for example.

A broken line in FIG. 11 indicates an outline of an opening 2o of the insulating protective film 2 on a solar battery module substrate on which the back surface electrode type solar battery cell 5′ is mounted. The outline of the opening 2o is positioned inside an outline 48 of the back surface electrode type solar battery cell 5′, and the outline 48 constitutes a projected portion when the back surface electrode type solar battery cell 5′ is mounted on the solar battery module substrate.

The solar battery module substrate on which the back surface electrode type solar battery cell 5′ is mounted includes an insulating protective film, a positive electrode mounting terminal, a negative electrode mounting terminal, module wiring connected with the positive electrode mounting terminal, and module wiring connected with the negative electrode mounting terminal, as in the case of the solar battery module substrate 1. The insulating protective film has an opening for exposing the positive electrode mounting terminal and the negative electrode mounting terminal. The opening is positioned to be inside the projected portion of the back surface electrode type solar battery cell 5′.

In the present embodiment, the number of solar battery cells to be connected with each other in series is not particularly limited. The two solar battery cells in FIG. 1 and the ten solar battery cells in FIG. 10 are merely examples. In general, an operating voltage of a logic IC is 5V, and an electromotive voltage per one cell is 0.5V. Accordingly, ten cells connected with each other in series allow an IC to operate. In this manner, the number of cells to be connected in series should be determined so that an operating voltage of a desired circuit can be obtained.

Further, in the solar battery modules 7 and 41, by making the color of the insulating protective film 2 equal to that of the surface of the back surface electrode type solar battery cell 5, the whole of the solar battery modules 7 and 41 have the color of the surface of the back surface electrode type solar battery cell 5. This makes an influence on the design of a device on which the solar battery modules 7 and 41 are mounted as small as possible.

### SUMMARY OF EMBODIMENTS

The solar battery module substrates 1, 22, and 31 may be arranged such that the conductive pattern further includes the module wiring 4a and 4b, and one edges of the module wiring 4a and 4b are connected with the cathode mounting terminal 3a and the anode mounting terminal 3b, respectively, and the other edges of the module wiring 4a and 4b are respectively connected with mounting electrodes (44a, 44b) connected with an electrode of a mounting substrate on which a solar battery module is mounted.

This allows electrical connection between the solar battery module obtained by mounting the solar battery cell on the solar battery module substrates 1, 22, and 31 and the mounting substrate.

The solar battery module 7 or 41 is obtained by mounting, on the solar battery module substrate 1, 22, or 31, at least two back surface electrode type solar battery cells 5 or at least two back surface electrode type solar battery cells 5′ on a back surface of which both of the cathode and the anode are provided. This allows the solar battery module 7 or 41 to fully exhibit a characteristic that the back surface electrode type solar battery cell 5 or 5′ does not suffer from a drop in optical power generation performance.

The solar battery modules 7 and 41 may be arranged such that at least a part of an electrode of the back surface electrode type solar battery cells 5 and 5′ is exposed at an edge of a cell.

Further, the solar battery modules 7 and 41 may be arranged such that at least one positive electrode 46 and at least one negative electrode 47 of the back surface electrode type solar battery cell 5′ are positioned in such a manner that electrodes of the same polarity are not adjacent to each other.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

In the solar battery module substrate of the present invention, a portion where an electrode is exposed does not contact with its surrounding improperly. Accordingly, the solar battery module substrate is applicable to a relatively small solar battery module mounted on a portable phone.

### REFERENCE SIGNS LIST

1, 22, 31: solar battery module substrate
2: insulating protective film (insulating protective film, first insulating protective film)
2a: insulating protective film (second insulating protective film)
2o: opening (opening)
3a, 24: cathode mounting terminal
3b, 25: anode mounting terminal
4a, 4b: module wiring
5, 5′: back surface electrode type solar battery cell (solar battery cell)
6: Transparent protective resin
7, 41: Solar battery module
12: Surface
13: Sun
14: Incident light
15: back surface
16, 46: Positive electrode (cathode)
17, 47: Negative electrode (anode)
18: Electron-hole pair
19: Electron
20: Hole
21: Back surface electrode type cell wafer for housing
23: Module wiring (first module wiring)
26: Solder paste
32o: Opening (first opening, second opening)
42, 43: Via
44a, 44b: Mounting electrode
45a, 45b: Test pad
48: Outline
D1: Cell distance
T: edge (cell edge)
W1: Distance

1. A solar battery module substrate on which solar battery cells are to be mounted, comprising an insulating substrate on which a conductive pattern and an insulating protective film are formed,
the conductive pattern including: cathode mounting terminals each of which is to be connected with a cathode of a solar battery cell; anode mounting terminals each of which is to be connected with an anode of the solar battery cell; and first module wiring,
the first module wiring connecting a cathode mounting terminal to be connected with a cathode of one solar battery cell with an anode mounting terminal to be connected with an anode of another solar battery cell connected in series with said one solar battery cell,
the insulating protective film having at least one opening for exposing the cathode mounting terminal and the anode mounting terminal, and
the opening being positioned inside a portion of the solar battery module substrate on which portion the solar battery cell is to be projected.

2. The solar battery module substrate as set forth in claim 1, wherein
the conductive pattern further includes second module wiring, and
one edge of the second module wiring is connected with the cathode mounting terminal or the anode mounting terminal, and the other edge of the second module wiring is connected with a mounting electrode connected with an electrode of a mounting electrode on which a solar battery module is to be mounted.

3. A solar battery module, comprising:
a solar battery module substrate as set forth in claim 1; and
at least two back surface electrode type solar battery cells provided as the solar battery cell on the solar battery module substrate, each of said at least two back surface electrode type solar battery cells being designed such that one or more cathodes and one or more anodes are positioned at a back surface thereof.

4. A solar battery module, comprising:
a solar battery module substrate as set forth in claims 2; and
at least two back surface electrode type solar battery cells provided as the solar battery cell on the solar battery module substrate, each of said at least two back surface electrode type solar battery cells being designed such that one or more cathodes and one or more anodes are positioned at a back surface thereof.

5. The solar battery module as set forth in claim 3, wherein a part of said one or more cathodes and said one or more anodes of the back surface electrode type solar battery cell is exposed at an edge thereof.

6. The solar battery module as set forth in claim 3, wherein said one or more cathodes and said one or more anodes of the back surface electrode type solar battery cell are positioned in such a manner that at least one cathode and at least one anode are provided both in two different directions and cathodes are not adjacent to each other and anodes are not adjacent to each other.

7. The solar battery module as set forth in claim 4, wherein at least a part of said one or more cathodes and said one or more anodes of the back surface type solar battery cell is exposed at an edge thereof.

8. The solar battery module as set forth in claim 4, wherein said one or more cathodes and said one or more anodes of the back surface electrode type solar battery cell are positioned in such a manner that at least one cathode and at least one anode are provided both in two different directions and cathodes are not adjacent to each other and anodes are not adjacent to each other.

9. A solar battery module substrate on which solar battery cells are to be mounted, comprising an insulating substrate on which a conductive pattern and a first insulating protective film are formed,
the conductive pattern including: cathode mounting terminals each of which is to be connected with a cathode of a solar battery cell; anode mounting terminals each of which is to be connected with an anode of the solar battery cell; and first module wiring,
the first module wiring connecting a cathode mounting terminal to be connected with a cathode of one solar battery cell with an anode mounting terminal to be connected with an anode of another solar battery cell connected in series with said one solar battery cell,
the first insulating protective film having at least one first opening for exposing the cathode mounting terminal and at least one second opening for exposing the anode mounting terminal,
said at least first opening and said at least one second opening being positioned inside a portion of the solar battery module substrate on which portion the solar battery cell is to be projected, and
a second insulating protective film being provided between the cathode mounting terminal and the anode mounting terminal.

10. The solar battery module substrate as set forth in claim 9, wherein
the conductive pattern further includes second module wiring, and
one edge of the second module wiring is connected with the cathode mounting terminal or the anode mounting terminal, and the other edge of the second module wiring is connected with a mounting electrode connected with an electrode of a mounting electrode on which a solar battery module is to be mounted.

11. A solar battery module, comprising:
a solar battery module substrate as set forth in claim 9; and
at least two back surface electrode type solar battery cells provided as the solar battery cell on the solar battery module substrate, each of said at least two back surface electrode type solar battery cells being designed such that one or more cathodes and one or more anodes are positioned at a back surface thereof.

12. A solar battery module, comprising:
a solar battery module substrate as set forth in claim 10; and
at least two back surface electrode type solar battery cells provided as the solar battery cell on the solar battery module substrate, each of said at least two back surface electrode type solar battery cells being designed such that one or more cathodes and one or more anodes are positioned at a back surface thereof.

13. The solar battery module as set forth in claim 11, wherein at least a part of said one or more cathodes and said one or more anodes of the back surface type solar battery cell is exposed at an edge thereof.

14. The solar battery module as set forth in claim 11, wherein said one or more cathodes and said one or more anodes of the back surface electrode type solar battery cell are positioned in such a manner that at least one cathode and at least one anode are provided both in two different directions and cathodes are not adjacent to each other and anodes are not adjacent to each other.

15. The solar battery module as set forth in claim 12, wherein at least a part of said one or more cathodes and said one or more anodes of the back surface type solar battery cell is exposed at an edge thereof.

16. The solar battery module as set forth in claim 12, wherein said one or more cathodes and said one or more anodes of the back surface electrode type solar battery cell are positioned in such a manner that at least one cathode and at least one anode are provided both in two different directions and cathodes are not adjacent to each other and anodes are not adjacent to each other.
